(19) United States
(12) Patent Application Publication
(10) Pub. No.: US 2012/0287114 A1
(43) Pub. Date: Nov. 15, 2012

(54) INTERFACE INCLUDING VIEWS POSITIONED IN ALONG MULTIPLE DIMENSIONS

(75) Inventors: Joseph Hallock, Renton, WA (US); Dileep Kumar, Redmond, WA (US); Kenneth Patrick Coleman, Bothell, WA (US); Lara Arguelles, Seattle, WA (US); Trinh Vo Yetzer, Kirkland, WA (US)

(73) Assignee: Microsoft Corporation, Redmond, WA (US)

(21) Appl. No.: 13/105,002

(22) Filed: May 11, 2011

(51) Int. Cl. G06T 1/00; G06F 3/048

(52) U.S. Cl. 345/418; 715/784

(57) ABSTRACT

A particular method includes generating an interface that includes a plurality of first views positioned along a first dimension. The interface also includes at least one second view positioned with respect to at least one of the first views along a second dimension. The method also includes transmitting the interface to a display device.

### BACKGROUND

Certain computer systems, such as backup systems or revision control systems (e.g., a source code version control system), may maintain multiple versions of files. For example, a new version of a file may be stored periodically (e.g., nightly) or whenever the contents of the file changes. Such systems may enable a user to revert a file back to any of the previously stored versions of the file. As the number of files maintained in the system increases, it may become difficult to quickly locate a desired version of a file or to determine the differences between different versions of a file.

### SUMMARY

An interface that includes views positioned along multiple dimensions is disclosed. In one implementation, each view positioned along a first (e.g., primary) dimension may represent a different version of a computer file, where each version was created or stored at a different time. One or more second views may be positioned with respect to the first views along a second dimension (e.g., “behind” the first views). The second views may represent different versions of a different computer file. When considered together, the views in the interface may provide a two-dimensional representation of multiple versions of different files in a computer folder or library. The interface may also include a control operable to perform synchronized scrolling of the views. The interface may be operable to highlight differences between content displayed in each of the views. For example, the control may enable concurrent scrolling of content within each of the views so that a user can quickly determine (e.g., based on the highlighting) relative differences between the content in each view. The interface may thus enable fast and convenient navigation and comparison of different versions of the same file or of different files of a computer system.

### BRIEF DESCRIPTION OF THE DRAWINGS

The present disclosure may be better understood, and its numerous features and advantages made apparent to those skilled in the art by referencing the accompanying drawings.

FIG. 1 is a diagram to illustrate a particular embodiment of an interface that includes views positioned along multiple dimensions;

FIG. 2 is a diagram to illustrate a particular embodiment of displaying previews of computer files;

FIG. 3 is a diagram to illustrate a particular embodiment of a method of generating and modifying an interface that includes views positioned along multiple dimensions; and

FIG. 4 is a diagram to illustrate a particular embodiment of a computing environment including a computing device to support systems, methods, and computer program products described in FIGS. 1-3.

The use of the same reference symbols in different drawings indicates similar or identical items.

### DETAILED DESCRIPTION

An interface may include views positioned along multiple dimensions. For example, a first dimension may be a primary dimension (e.g. a time dimension) and a second dimension may be a secondary dimension (e.g. a depth dimension). Different versions of a first computer file may be positioned along the time dimension, and versions of other computer files may be positioned “behind” the versions of the first computer file along the depth dimension (e.g., depth of a computer folder or computer library that includes the first computer file and the other computer files). In one implementation, the interface includes a synchronized scroll bar to concurrently scroll content within multiple views. The interface may also be operable to highlight differences between content within each view, thereby enabling a user to quickly identify differences between the content in each view. The interface may thus enable fast and convenient navigation and comparison of different versions of the same file or of different files.

In a particular embodiment, a computer-implemented method includes generating an interface that includes a plurality of first views positioned along a first dimension, where each particular view of the plurality of first views corresponds to a particular version of a computer object (e.g., computer file, folder, or library). At least one second view is positioned with respect to at least one of the first views along a second dimension (e.g. “behind” the first view). The method also includes transmitting the interface to a display device.

In another particular embodiment, a computer-readable storage medium includes instructions that, when executed by a computer cause the computer to generate an interface that includes a plurality of views positioned along a first dimension. For example, each particular view may correspond to a particular version of a computer object. The interface also includes a scroll control that is operable to concurrently scroll content displayed within each of the plurality of views. The instructions are also executable by the computer to transmit the interface to a display device.

In another particular embodiment, a computer system includes an input interface configured to receive input, an output interface configured to transmit a graphical user interface (GUI) for display, a processor, and a memory storing instructions executable by the processor to generate the GUI. The GUI includes a plurality of first views positioned along a first dimension, where each particular first view corresponds to a particular version of a first computer object. The GUI also includes at least one second view positioned with respect to at least one of the first views along a second dimension. The at least one second view may correspond to at least one version of a second computer object that is different from the first computer object. The GUI is responsive to a first control to scroll along the first dimension, where scrolling along the first dimension modifies the interface to replace at least one of the first views with at least one additional view of at least one additional version of the first computer object. The GUI is also responsive to a second control to scroll along the second dimension, where scrolling along the second dimension modifies the interface by replacing the plurality of first views corresponding to the first computer object with the at least one second view corresponding to the second computer object. The GUI is further responsive to a third control to concurrently scroll content displayed within each of the plurality of first views.

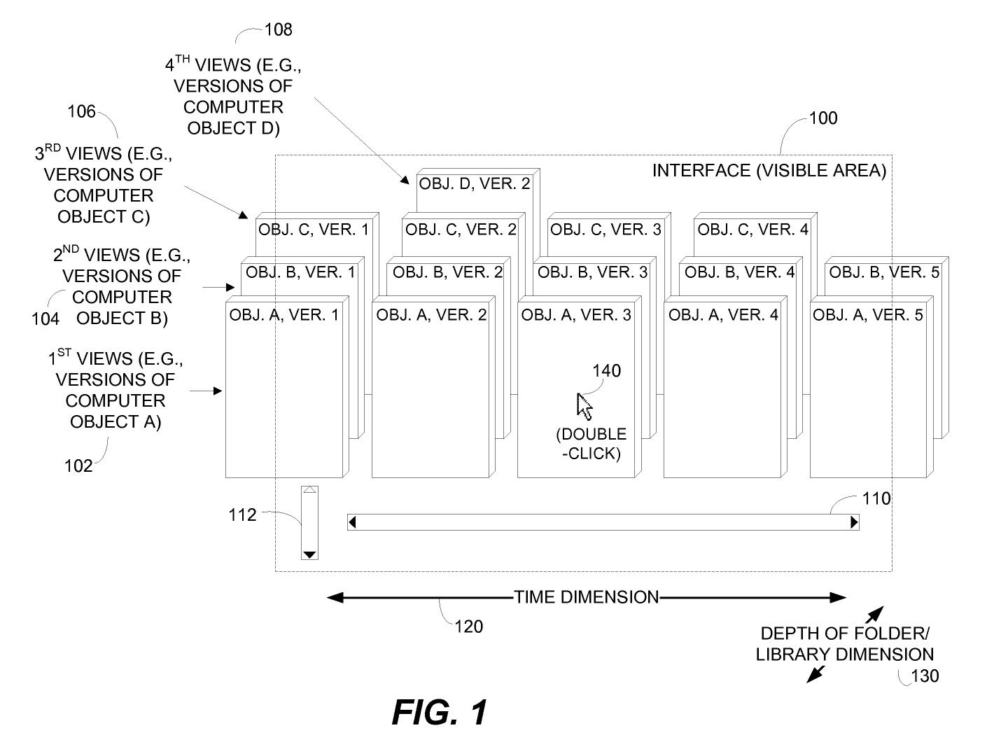

Referring to FIG. 1, a particular illustrative embodiment of an interface 100 is shown. The interface 100 may be a graphical user interface (GUI) that is displayed on a display device, such as a computer monitor, television, display of an electronic device (e.g., a smartphone or a tablet computing device), or other type of display device.

The interface 100 includes a plurality of first views 102. Each of the plurality of first views 102 is arranged along a first dimension. In a particular embodiment, the first dimension is a time dimension 120, as shown. The interface 100 further includes a plurality of second views 104. In a particular illustrative embodiment, the plurality of first views 102 corresponds to different versions of a particular computer object (e.g. object A), and the plurality of second views 104 includes different versions of a different computer object (e.g. object B). Similarly, the interface 100 may include a plurality of third views 106 where each of the third views corresponds to different versions of another computer object (e.g. object C). In addition, at least one fourth view 108 may also be displayed. The fourth view 108 may display a particular version of yet another computer object (e.g. object D), as illustrated.

In addition to the time dimension 120, the interface 100 also includes a second dimension 130. In a particular embodiment, the second dimension 130 represents a depth of a computer folder or computer library. The first dimension (e.g. time) may correspond to a first direction (e.g. left and right at the interface 100) and the second dimension (e.g. depth of folder/library) may correspond to a second direction (a direction into or out of the interface 100, as illustrated in FIG. 1 by a 3-D perspective direction). Each of the views 102, 104, 106, and 108 may correspond to computer objects that are stored within a computer folder or a computer library (e.g., by a backup application executing at a computer system). One or more of the views 102, 104, 106, and 108 may also represent a computer folder or a computer library. For example, when a particular version of a representative computer object is a folder, the folder may include a plurality of other computer objects (e.g. a plurality of computer files). To illustrate, when the computer object A is a folder or a library, each of the views 102 may be selectable to “drill-down” and view the contents of the folder or library as the folder or library existed at a particular point in time. Each particular view may also be selectable to restore the particular version of the particular computer file, computer folder, or computer library represented by the view. For example, restoring a particular version of a computer file may include copying the particular version of the computer file from a backup computer system to an active or primary computer system. The interface 100 may also display other types of objects, such as representations of devices (e.g., computers, smartphones, or tablets). To illustrate, the interface 100 may represent a backup of multiple devices (e.g., computers, smartphones, or tablets) at an enterprise or business. Each object of the interface 100 may represent a specific device that is backed up at a specific point in time along the time dimension 120. Drilling down on a particular object may display hard disks, libraries, folders and files that are backed up from the corresponding device.

In a particular embodiment, one or more of the first views 102 may be shown in a full view mode (e.g. in their entirety) at the interface 100, but the views 104, 106, and 108 may be partially obscured. For example, the view corresponding to version 2 of the computer object A is displayed in full view mode, but the views corresponding to objects B, C, and D are obscured and are displayed in a partial view mode, as illustrated. The interface 100 thus shows the computer object A, which may be a folder or library, as well as a portion of the other objects B, C, and D that are included within the folder or library of the computer object A. A user may use the interface 100 to visualize and navigate between different objects along the depth of folder/library dimension 130.

In a particular illustrative embodiment, each of the plurality of first views 102 represents a particular version of a particular computer object at a particular point in time. The point in time may be a time of creation of the object or a storage time for the particular version of the object. For example, a first version (ver. 1), a second version (ver. 2), a third version (ver. 3), a fourth version (ver. 4), and a fifth version (ver. 5). The versions (ver. 1-ver. 5) may be arranged in order from the earliest version at the left of the interface 100 to the latest version at the right of the interface 100.

In a particular embodiment, the interface 100 may be responsive to a first control to navigate along the first dimension 120. For example, the first control may be a graphical control (e.g., illustrated as a scroll bar 110) displayed by the interface 100. Alternately, the first control may be a control that is not displayed by the interface 100, such as a keyboard keystroke (e.g., a left arrow keystroke or a right arrow keystroke), a mouse movement, a mouse click, a mouse scroll, a touchscreen input (e.g., a swipe left gesture or a swipe right gesture), or a motion gesture (e.g., captured by a motion capture device). When user input is received (e.g. via the scroll bar 110), the interface 100 may replace one or more of the first views 102 with another first view 102. To illustrate, the interface 100 may initially include the first views 102 corresponding to version 2, version 3, and version 4 of the object A. When the user scrolls left, the interface 100 may be modified to include the view of version 1 of the object A while the view of version 4 of the object A is removed from the interface 100. The interface 100 may similarly “pan left” with respect to the views 104, 106, and 108 of the other computer objects. Conversely, when the user scrolls right, the interface 100 may “pan right” to include the view of version 5 of the object A while the view of version 2 of the object A is removed.

In a particular embodiment, the interface 100 may be responsive to a second control to replace the first views 102 with another set of views. For example, in the illustration of FIG. 1, the first views 102 may be considered to be located at the “front” of the interface 100. In response to a second scroll bar 112 (or other user input or control mechanism), the second views 104 corresponding to the object B may be placed at the “front” of the interface 100. The first views 102 may be removed from the interface or may be placed at the “back” of the interface (i.e., “behind” the fourth views 108 corresponding to the computer object D. The second scroll bar 112 may thus be operable to navigate along the second dimension 130.

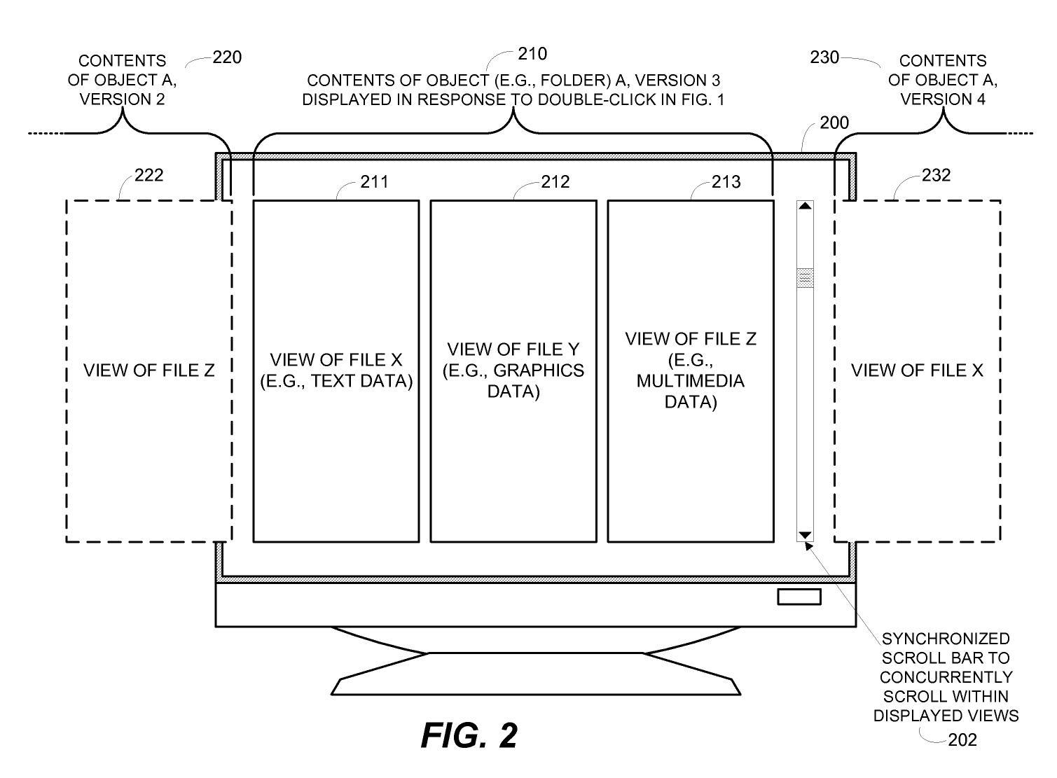

During operation, a user may navigate between the various views 102, 104, 106, and 108 along multiple dimensions using the scroll bars 110, 112 of the interface 100. In order to obtain information related to a particular version of a computer object, the user may select the view corresponding to the particular version of the computer object. For example, the user may double-click the view corresponding to version 3 of the computer object A, as shown at 140. When the view that is double-clicked corresponds to a folder or library, the folder or library may become the subject of a subsequent interface, as illustrated in FIG. 2. Alternately, when the view corresponds to a version of a single computer file, a preview of the version of the computer file may be shown or the version of the computer file may be restored in response to the double-click or in response to an additional user action. The interface 100 may thus enable recursive navigation of multiple versions of multiple computer objects.

In a particular embodiment, a computing device may be operable to dynamically change how many views are included in the interface 100. For example, how many views to include in a displayed graphical user interface may be determined based on user input, a resolution of a display device, or any combination thereof.

While FIG. 1 illustrates an embodiment where other objects displayed along a second dimension behind a computer library or computer folder contain different objects, it should be understood that a displayed library or folder may contain different versions of the same object. For example, version 3 of the computer object A may represent a folder that contains other versions of the computer object A. Thus, the interface 100 may be used to navigate along a first dimension, such as the dimension of time, while also allowing the user to navigate along a second dimension, such as a hierarchical dimension to traverse computer folders, libraries, subfolders, or to locate particular files within such folders or libraries. In response to user input (e.g., input received via either of the scroll bars 110 and 112), the interface 100 may be modified and transmitted to a display device for rendering.

Referring to FIG. 2, a particular embodiment of a display device 200 displaying an interface is shown. The interface includes content items 210 corresponding to a computer object. For example, in FIG. 1, the computer object may be the folder represented by the first view 102 of version 3 of the object A, and the interface depicted in FIG. 2 may be displayed in response to the double-click 140 in FIG. 1. The plurality of displayed content items includes a first representative view 211, a second representative view 212, and a third representative view 213. In a particular embodiment, the first view 211 is a view of a file X having a first content type, such as text data. The second view 212 is a view of a file Y having a second content type, such as graphics data. The third view 213 is a view of a file Z with a different content type, such as multimedia data. Each of the files X, Y, and Z may be stored within version 3 of the computer object A (e.g. folder A or library A). Thus, files having different content types may be displayed side by side to allow user inspection and navigation.

In a particular embodiment, the display device 200 may also display a navigation control. In a particular embodiment, the navigation control is a synchronized scroll bar 202 to enable concurrent scrolling of content within each of the displayed views 211, 212, and 213.

In addition, while not currently displayed by the display device 200, the view of the contents of version 2 of the object A (220) or a view of the contents of version 4 of the object A (230) may be displayed in response to a user scrolling along the time dimension. For example, if the user scrolls to the left using the scroll bar 110 (not shown in FIG. 2), the view of file Z 222 of version 2 of the object A may be displayed within the display window 200. Similarly, in response to the user scrolling right using the scroll bar 110, a view of file X 232 of version 4 of the object A 230 may be displayed within the display device window 200.

It should be noted that the interfaces depicted in FIGS. 1 and 2 may not be separate interfaces. For example, a single graphical user interface (GUI) may include all or a portion of the functionality described with reference to interfaces in FIGS. 1-2. To illustrate, such a GUI may include the plurality of first views 102 corresponding to different versions of a first computer object (e.g., object A) and one or more of the second views 104 corresponding to different versions of a second computer object (e.g., object B). The GUI may also be responsive to a first control (e.g., the scroll bar 110) to navigate along the time dimension 120, a second control (e.g., the scroll bar 112) to navigate along the depth dimension 130, and a third control (e.g., the synchronized scroll bar 202) to concurrently scroll content displayed within multiple views (e.g., the views 211-213 of FIG. 2). The GUI may visually indicate (e.g., highlight) differences between the content displayed within each of the views. For example, added content may be displayed in underline and deleted content may be displayed in strikethrough. Variations in color, font, size, and layout may also be used to highlight changes in content.

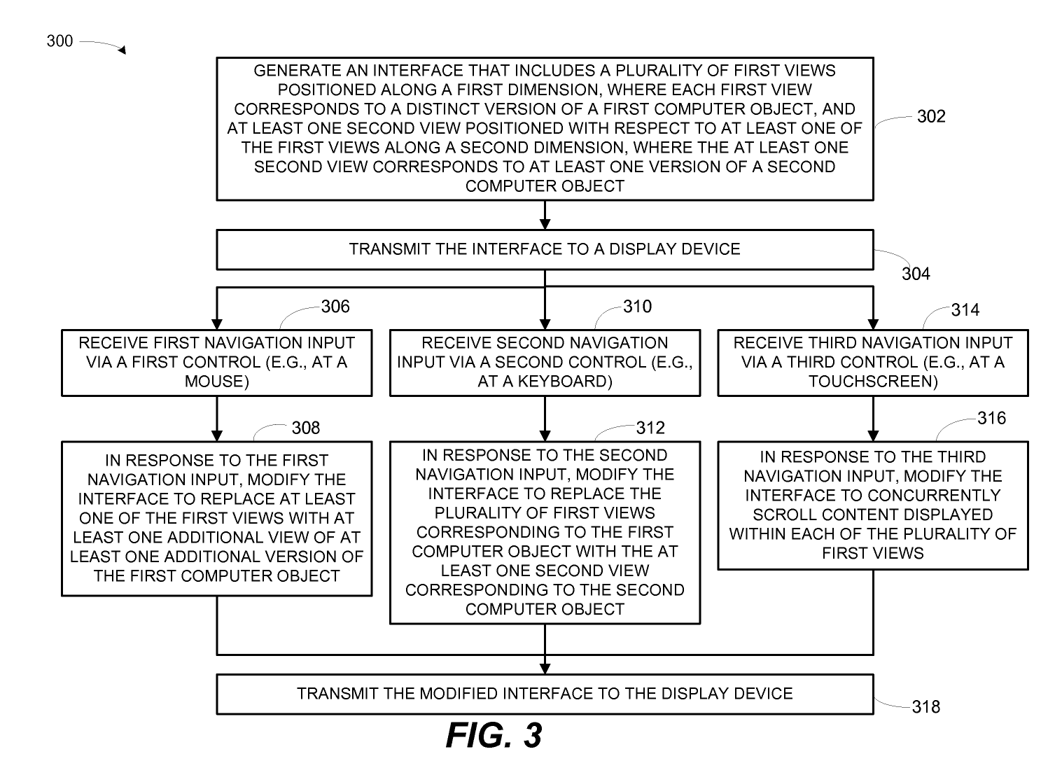

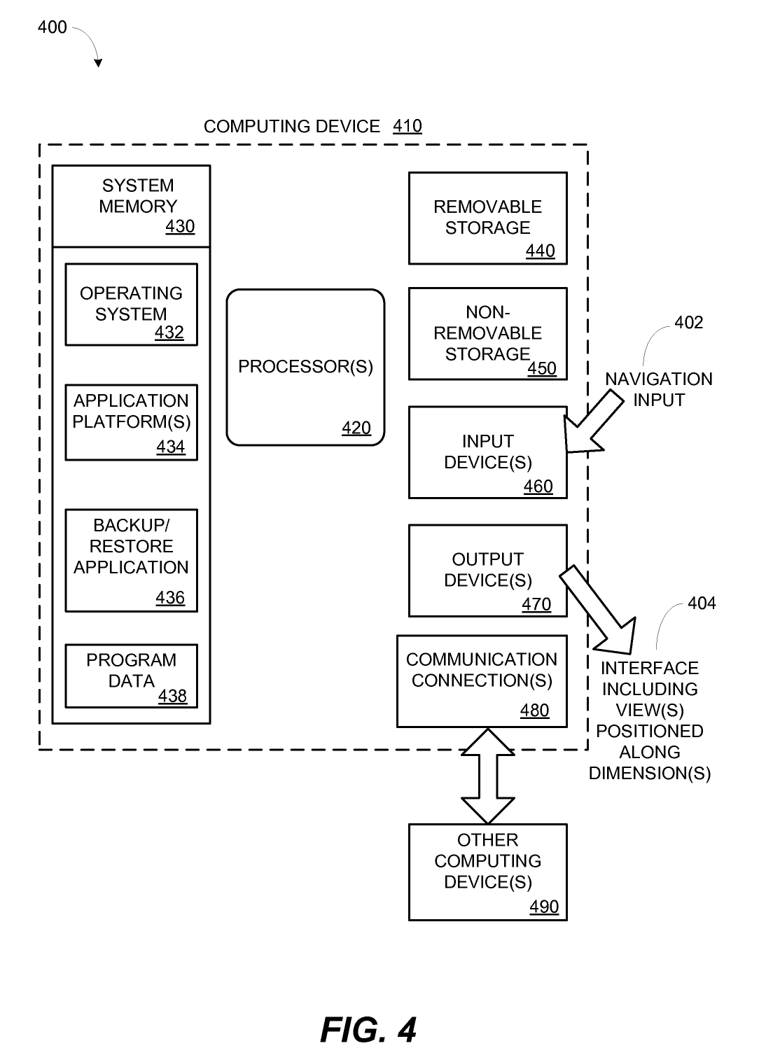

Referring to FIG. 3, a particular embodiment of a computer-implemented method 300 is shown. In an illustrative embodiment, the method 300 may be performed by a computing device, such as the computing device depicted in FIG. 4, and may be illustrated with reference to FIGS. 1-2.

The method 300 includes generating an interface that includes a plurality of first views positioned along a first dimension, at 302. In a particular illustrative embodiment, each of the first views corresponds to a distinct version of a first computer object and at least one second view is positioned with respect to one of the first views along a second dimension. The at least one second view corresponds to at least one version of a second computer object. For example, in FIG. 1, the first views may be the first views 102 corresponding to the object A and the at least one second view may be the second views 104 corresponding to the object B. In alternate embodiments, the views may correspond to data other than computer objects, and the dimensions may be dimensions other than time (e.g., a distance dimension when viewing population data or a mass dimension when viewing physics or engineering data).

The method 300 further includes transmitting the interface to a display device, at 304. The method 300 further includes receiving navigation input and modifying the interface in response to the navigation input. For example, the method 300 includes an option of receiving first navigation input via a first control, at 306. The first navigation input may be received via a user device such as a computer mouse. In response to receiving the first navigation input, at 306, the method 300 further includes modifying the interface to replace at least one of the first views with at least one additional view of at least one additional version of the first computer object, at 308. For example, the user may scroll left or right using the scroll bar 110. Upon user scrolling, a particular version of the computer object A may be removed from the display 100 while a previously undisplayed version of the computer object A may be displayed. For example, as the user scrolls right using the toolbar 110, version 1 of the computer object A may be displayed on the screen while version 4 of the computer object A is removed from the screen.

The computer implemented method 300 may further include an option of receiving second navigation input via a second control, at 310. For example, the second navigation input may be received via a keyboard of a computer device. In response to the second navigation input, the method 300 may include modifying the interface to replace the plurality of first views corresponding to the first computer object with at least one second view corresponding to the second computer object, at 312. For example, objects that were previously displayed in a partially obscured mode may be displayed in a full display mode in response to user input (such as a keyboard input) or an input at the second scroll bar 112 of FIG. 1.

The method 300 may optionally include receiving third navigation input via a third control (e.g., at the synchronized scroll bar 202 of FIG. 2 or at a touch screen), at 314. In response to the third navigation input, the method may modify the interface to concurrently scroll within each of the plurality of first views, at 316. For example, a user may navigate using the synchronized scroll bar 202 to scroll vertically (either up or down) content displayed concurrently within each of the views 211-213. Differences between the content within each of the views may be highlighted. Subsequent to modifying the interface, the method 300 further includes transmitting the modified interface to the display device, at 318.

The interface may be navigated by user control using one or more types of input. In response to such input via a user input device, the interface may be modified to permit user navigation of various versions of computer objects. In addition, the user may navigate along multiple dimensions and may take actions to perform synchronized scrolling and other actions to display information regarding versions of computer objects that may be stored by a computer system. Each version of a computer file may be created or stored at a different time, and the interface may be operable to selectively view, compare, and restore specific versions of the computer objects.

FIG. 4 depicts a block diagram of a computing environment 400 that includes a computing device 410 operable to support embodiments of systems, methods, and computer program products according to the present disclosure.

The computing device 410 includes at least one processor 420 and a system memory 430. Depending on the configuration and type of the computing device 410, the system memory 430 may be volatile (such as random access memory or “RAM”), non-volatile (such as read-only memory or “ROM,” flash memory, and similar memory devices that maintain stored data even when power is not provided), or some combination of the two. The system memory 430 typically includes an operating system 432, one or more application platforms 434, one or more applications, and program data 438. For example, the one or more applications may include a backup and restore application 436 operable to generate and modify interfaces as described herein. In an illustrative embodiment, the backup and restore application 436 may be represented by instructions that are executable by the processor(s) 420 to perform the functions and methods disclosed herein. For example, the backup and restore application 436 may generate and modify the interface 100 of FIG. 1, the interface displayed by the display device 200 of FIG. 2, and additional interfaces as described herein. To illustrate, the backup and restore application 436 may generate and receive input via controls such as the scroll bars 110, 112 of FIG. 2 and the synchronized scroll bar 202 of FIG. 2. Alternately, backup and restore functions may be performed by the operating system 432 instead of a specific application. In another embodiment, a user interface application may generate and modify the interface 100 of FIG. 1, the interface displayed by the display device 200 of FIG. 2, and other interface features as described herein.

The computing device 410 may also have additional features or functionality. For example, the computing device 410 may include removable and/or non-removable additional data storage devices, such as magnetic disks, optical disks, tape devices, and standard-sized or flash memory cards. Such additional storage is illustrated in FIG. 4 by removable storage 440 and non-removable storage 450. Computer storage media may include volatile and/or non-volatile storage and removable and/or non-removable media implemented in any technology for storage of information such as computer-readable instructions, data structures, program components or other data. The system memory 430, the removable storage 440 and the non-removable storage 450 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 410. Any such computer storage media may be part of the computing device 410.

The computing device 410 may also have input device(s) 460, such as a keyboard, mouse, pen, voice input device, touch input device, motion or gesture input device, etc, connected via one or more wired or wireless input interfaces. In an illustrative embodiment, the input device(s) 460 may receive navigation input 402 (e.g., at a scroll bar generated by an application, such as the scroll bars 110, 112 of FIG. 1 or the synchronized scroll bar 202 of FIG. 2). Output device(s) 470, such as a display (e.g., the display device 200 of FIG. 2), speakers, printer, etc. may also be connected via one or more wired or wireless output interfaces. In an illustrative embodiment, the output device(s) may output an interface 404 that includes views positioned along one or more dimensions (e.g., an interface generated by the backup and restore application 436 (or another application), such as the interface 100 of FIG. 1 or the interface displayed by the display device 200 of FIG. 2).

The computing device 410 also contains one or more communication connections that allow the computing device 410 to communicate with other computing devices 490 over a wired or a wireless network. It will be appreciated that not all of the components or devices illustrated in FIG. 4 or otherwise described in the previous paragraphs are necessary to support embodiments as herein described. For example, the removable storage 440 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-implemented method, comprising
generating an interface that includes:
a plurality of first views positioned along a first dimension, wherein each particular view of the plurality of first views corresponds to a particular version of a computer object; and
at least one second view positioned with respect to at least one of the first views along a second dimension; and
transmitting the interface to a display device.

2. The computer-implemented method of claim 1, wherein the first dimension corresponds to a first direction and the second dimension corresponds to a second direction.

3. The computer-implemented method of claim 1, wherein the first dimension corresponds to time.

4. The computer-implemented method of claim 1, wherein the second dimension corresponds to depth within a computer folder or computer library.

5. The computer-implemented method of claim 1, wherein the at least one second view is at least partially obscured by the at least one first view.

6. The computer-implemented method of claim 1, wherein the computer object comprises a computer folder, a computer library, or a computer file.

7. The computer-implemented method of claim 1, wherein the interface is responsive to a first control to scroll along the first dimension.

8. The computer-implemented method of claim 7, wherein the first control comprises a graphical control that is displayed by the interface.

9. The computer-implemented method of claim 7, wherein the first control comprises a keyboard keystroke, a mouse movement, a mouse click, or a mouse scroll.

10. The computer-implemented method of claim 7, wherein the first control comprises an input received via a touchscreen.

11. The computer-implemented method of claim 7, further comprising:
receiving first navigation input via the first control;
in response to the first navigation input, modifying the interface to replace at least one of the first views with at least one additional view of at least one additional version of the computer object; and
transmitting the modified interface to the display device.

12. The computer implemented method of claim 1, wherein the at least one second view corresponds to at least one version of a second computer object that is different from the computer object.

13. The computer-implemented method of claim 12, wherein the interface is responsive to a second control to scroll along the second dimension.

14. The computer-implemented method of claim 13, further comprising:
receiving second navigation input via the second control;
in response to the second navigation input, modifying the interface by replacing the plurality of first views corresponding to the computer object with the at least one second view corresponding to the second computer object; and
transmitting the modified interface to the display device.

15. The computer-implemented method of claim 1, wherein the interface includes a single scroll control that is operable to concurrently scroll content displayed within each of a plurality of views and wherein the interface is operable to indicate differences between the content displayed within each of the plurality of views.

16. A computer-readable medium comprising instructions that, when executed by a computer, cause the computer to:
generating an interface that includes:
a plurality of views positioned along a first dimension; and
a scroll control that is operable to concurrently scroll content displayed within each of the plurality of views; and
transmitting the interface to a display device.

17. The computer-readable medium of claim 16, wherein each particular view of the plurality of views corresponds to a particular version of a computer object, wherein the first dimension is time, and wherein the plurality of views are displayed in an order based on a creation time or a storage time of each of the versions of the computer object.

18. A computer system, comprising:
an input interface configured to receive input;
a processor;
a memory storing instructions executable by the processor to generate a graphical user interface that includes:
a plurality of first views positioned along a first dimension, wherein each particular first view of the plurality of first views corresponds to a particular version of a first computer object; and
at least one second view positioned with respect to at least one of the plurality of first views along a second dimension, wherein the at least one second view corresponds to at least one version of a second computer object that is different from the first computer object,
wherein the graphical user interface is responsive to a first control to scroll along the first dimension, wherein scrolling along the first dimension modifies the interface to replace at least one of the first views with at least one additional view of at least one additional version of the first computer object;
wherein the graphical user interface is responsive to a second control to scroll along the second dimension, wherein scrolling along the second dimension modifies the interface by replacing the plurality of first views corresponding to the first computer object with the at least one second view corresponding to the second computer object, and
wherein the graphical user interface is responsive to a third control to concurrently scroll content; and
an output interface configured to transmit the graphical user interface for display.

19. The computer system of claim 18, wherein the first computer object comprises text data, graphics data, multimedia data, or any combination thereof.

20. The computer system of claim 18, wherein the instructions are further executable to modify a number of views to include in the graphical user interface based on input received via the input interface, a resolution of a display device coupled to the output interface, or any combination thereof.
